(19) United States
(12) Patent Application Publication
(10) Pub. No.: US 2023/0061564 A1
(43) Pub. Date: Mar. 2, 2023

(54) Optical Waveguide System and Near-eye Display

(71) Applicant: Sunny Omnilight Technology Co.,Ltd., Yuyao (CN)

(72) Inventors: Yifeng GAO, Yuyao (CN); Linghe XIONG, Yuyao (CN); Libin SUN, Yuyao (CN); Jie WANG, Yuyao (CN); Yuan CHEN, Yuyao (CN)

(21) Appl. No.: 17/879,808

(22) Filed: Aug. 3, 2022

(30) Foreign Application Priority Data
Aug. 25, 2021 (CN) 202110983401.3

(51) Int. Cl. F21V 8/00; G02B 27/01

(52) U.S. Cl. CPC G02B 6/0016; G02B 6/0038; G02B 27/0172

(57) ABSTRACT

The disclosure provides an optical waveguide system and a near-eye display. An optical waveguide system includes: an optical waveguide; an in-coupling grating, arranged on one side surface of the optical waveguide, the in-coupling grating is a one-dimensional grating, and is configured for coupling light emitted by a micro-projector located externally into the optical waveguide; a turning grating, arranged on the optical waveguide and is located on the same side surface or a different side surface of the in-coupling grating, the turning grating is a two-dimensional grating, and is configured for receiving light of the in-coupling grating; and an out-coupling grating, arranged on the other side surface of the optical waveguide, projections of the turning grating and the out-coupling grating on the optical waveguide at least partially coincide, the out-coupling grating is a one-dimensional grating.

### CROSS-REFERENCE TO RELATED APPLICATION

The disclosure claims priority to and the benefit of Chinese Patent Application No. 202110983401.3, filed to the China National Intellectual Property Administration (CHIPA) on 25 Aug. 2021, which is hereby incorporated by reference in its entirety.

### TECHNICAL FIELD

The disclosure relates to the technical field of diffractive optical imaging devices, and in particular to an optical waveguide system and a near-eye display.

### BACKGROUND

With the continuous development and innovation of science and technology, virtual reality (VR), augmented reality (AR) and mixed reality (MR) have gradually applied to people's lives. With regard to AR, an optical waveguide technique is indispensable, it uses a flat optical waveguide with a diffraction grating to transmit and expand to human eyes, image light emitted by a micro-projector, so that while viewing the real world, a wearer can observe a virtual image that is projected by a micro-projector and superimposed on the real world.

The display technology generally comprises a micro-projector and an optical waveguide system. The micro-projector provides single-color or colorful image information, and the optical waveguide system is responsible for expanding and transmitting the image of the micro-projector to the human eyes. The design and combination manner of a micro-projector and an optical waveguide system determines the form of a finally formed product. However, current products have some limitations, the biggest problem is that a display effect is not ideal, and the reasons are that transmission of light in the waveguide will cause a loss of light intensity and characteristics of diffraction grating will lead to an uneven efficiency of out-coupling light. Such non-uniformity will affect an image display, resulting in poor imaging observed by the human eyes.

That is to say, the optical waveguide system in the related art has the problem of poor imaging.

### SUMMARY

The main object of the disclosure is to provide an optical waveguide system and a near-eye display, so as to solve the problem of poor imaging effect of the optical waveguide system in the related art.

In order to achieve the object, an embodiment of the disclosure provides an optical waveguide system, which includes: an optical waveguide; an in-coupling grating, the in-coupling grating is arranged on one side surface of the optical waveguide, the in-coupling grating is a one-dimensional grating, and the in-coupling grating is configured for coupling light emitted by a micro-projector located externally into the optical waveguide; a turning grating, the turning grating is arranged on the optical waveguide and is located on the same side surface or a different side surface of the in-coupling grating, the turning grating is a two-dimensional grating, and the turning grating is configured for receiving light of the in-coupling grating; and an out-coupling grating, the out-coupling grating is arranged on the other side surface of the optical waveguide, projections of the turning grating and the out-coupling grating on the optical waveguide at least partially coincide, the out-coupling grating is a one-dimensional grating, and the out-coupling grating is configured for receiving lights of the turning grating and the in-coupling grating and output the lights to human eyes from the optical waveguide.

In an implementation mode, there are a plurality of in-coupling gratings, the plurality of in-coupling gratings are located on one side of the turning grating, and the plurality of coupling gratings are arranged at intervals along a straight line.

In an implementation mode, there are one or a plurality of optical waveguides; when there are the plurality of optical waveguides, the plurality of optical waveguides are arranged in a stacked manner; the in-coupling grating, the turning grating and the out-coupling grating are correspondingly arranged on each of the plurality of optical waveguides; and projections, on adjacent optical waveguide, of each of the in-coupling gratings on the plurality of optical waveguides coincide or do not coincide.

In an implementation mode, the optical waveguide further includes a functional area grating, the functional area grating is arranged between the in-coupling grating and the turning grating, the functional area grating is a one-dimensional grating, and the functional area grating is configured for turning and transmitting the light of the in-coupling grating, and then entering the turning grating.

In an implementation mode, the one-dimensional grating is one of a blazed grating, a slanted grating, a binary grating, a double-ridged grating and a one-dimensional multi-layer grating; and/or

the two-dimensional grating is one of a square grating, a rectangular grating, a parallelogram grating, a diamond grating and a two-dimensional multi-layer grating.

In an implementation mode, a duty ratio of the in-coupling grating is greater than or equal to 30% and less than or equal to 80%; and/or

when the in-coupling grating is a one-dimensional multi-layer grating, a number of layers of the one-dimensional multi-layer grating is greater than or equal to 1 and less than or equal to 10; and/or

a height of the in-coupling grating is greater than or equal to 50 nm and less than or equal to 500 nm; and/or

a period of the in-coupling grating is greater than or equal to 300 nm and less than or equal to 600 nm.

In an implementation mode, a duty ratio of the turning grating is greater than or equal to 30% and less than or equal to 80%; and/or

when the turning grating is a two-dimensional multi-layer grating, a number of layers of the two-dimensional multi-layer grating is greater than or equal to 1 and less than or equal to 10; and/or

a height of the in-coupling grating is greater than or equal to 30 nm and less than or equal to 300 nm; and/or

a period of the turning grating is greater than or equal to 300 nm and less than or equal to 600 nm.

In an implementation mode, a duty ratio of the out-coupling grating is greater than or equal to 30% and less than or equal to 80%; and/or

when the out-coupling grating is a one-dimensional multi-layer grating, a number of layers of the one-dimensional multi-layer grating is greater than or equal to 1 and less than or equal to 10; and/or

a height of the out-coupling grating is greater than or equal to 30 nm and less than or equal to 300 nm; and/or

a period of the out-coupling grating is greater than or equal to 300 nm and less than or equal to 600 nm.

In an implementation mode, a material of the optical waveguide is glass or optical crystal, the glass is a high refractive index glass, and the optical crystal is a high refractive index optical crystal; and/or

a refractive index of the optical waveguide is greater than or equal to 1.7 and less than or equal to 2.3; and/or

a thickness of the optical waveguide is equal to or greater than 400 μm and equal to or less than 1 mm.

Another embodiment of the disclosure provides a near-eye display, which includes: a micro-projector, there are one or more micro-projectors; the optical waveguide system, the micro-projector emits image light to the optical waveguide system, and the optical waveguide system couples the image light out, and then enters to human eyes.

By applying the technical solution of the disclosure, an optical waveguide system includes an optical waveguide, an in-coupling grating, a turning grating and an out-coupling grating, the in-coupling grating is arranged on one side surface of the optical waveguide, the in-coupling grating is a one-dimensional grating, and the in-coupling grating is configured for coupling light emitted by a micro-projector located externally into the optical waveguide; the turning grating is arranged on the optical waveguide and is located on the same side surface or a different side surface of the in-coupling grating, the turning grating is a two-dimensional grating, and the turning grating is configured for receiving light of the in-coupling grating; the out-coupling grating is arranged on the other side surface of the optical waveguide, projections of the turning grating and the out-coupling grating on the optical waveguide at least partially coincide, the out-coupling grating is a one-dimensional grating, and the out-coupling grating is configured for receiving lights of the turning grating and the in-coupling grating and coupling the lights out from the optical waveguide.

An arrangement of the optical waveguide enables the optical waveguide to provide arrangement positions for the in-coupling grating, the turning grating and the out-coupling grating, thereby improving usage reliabilities of the in-coupling grating, the turning grating and the out-coupling grating, meanwhile, ensuring an uniformity of transmission of light in the optical waveguide, and ensuring that the optical waveguide system is able to achieve uniform imaging. The in-coupling grating is the one-dimensional grating, so that the in-coupling grating is able to couple most of the light emitted by the micro-projector located externally into the optical waveguide, so that the in-coupling grating diffracts the light into light of different angles and different orders for transmission, thereby guaranteeing an uniformity of the light transmission in the optical waveguide, and guaranteeing an in-coupling efficiency of the in-coupling grating. The turning grating is arranged on the optical waveguide and is located on the same side surface or a different side surface of the coupling grating, the turning grating is a two-dimensional grating, so that the turning grating is able to receive most of the light of the in-coupling grating; the light in the optical waveguide is able to be transmitted in a one-dimensional direction or a two-dimensional direction, so as to transmit the light in two specific directions; and an image information of the micro-projector is expanded and transmitted, so as to ensure an expanding and uniform light effect of the turning grating. The out-coupling grating is arranged on the other side surface of the optical waveguide, the out-coupling grating is the one-dimensional grating, and the out-coupling grating is configured for receiving the lights of the turning grating and the in-coupling grating, and efficiently coupling the lights out from the optical waveguide, so as to uniformly and efficiently couple information of the micro-projector out and enter the human eyes. The projections of the turning grating and the out-coupling grating on the optical waveguide at least partially coincide, such arrangement shortens a distance for light to be transmitted from the turning grating to the out-coupling grating, reduces a loss of light intensity energy, increases an out-coupling efficiency, meanwhile, makes the light coupled to the human eyes more uniform, thereby guaranteeing an uniformity of the out-coupled light, enabling an image viewed by a user to be clearer and more uniform, and improving an imaging effect.

In addition, the projections of the turning grating and the out-coupling grating on the optical waveguide at least partially coincide, and this arrangement is able to effectively reduce an occupation area of the turning grating and the out-coupling grating on the optical waveguide, thereby ensuring a miniaturization of the optical waveguide system. Thus, the optical waveguide system of the disclosure is able to obtain a uniform display image by using a relatively small optical waveguide, thereby improving a display uniformity.

### BRIEF DESCRIPTION OF THE DRAWINGS

The drawings of the description, constituting a part of the disclosure, are configured for providing further understanding of the disclosure, and the illustrative embodiments of the disclosure and illustrations thereof are used to explain the disclosure, rather than constitute inappropriate limitation on the disclosure. In the drawings:

FIG. 1 shows a structural schematic diagram of an optical waveguide system according to an embodiment of the disclosure;

FIG. 2 shows a structural schematic diagram of the optical waveguide system in FIG. 1 from another angle;

FIG. 3 shows a structural schematic diagram of a near-eye display according to the disclosure;

FIG. 4 shows a structural schematic diagram of an optical waveguide system according to another embodiment of the disclosure;

FIG. 5 shows a structural schematic diagram of an optical waveguide system according to another embodiment of the disclosure; and

FIG. 6 shows a structural schematic diagram of an optical waveguide system according to another embodiment of the disclosure.

The above drawings include the following reference signs:

10, an optical waveguide; 20, an in-coupling grating; 30, a turning grating; 40, an out-coupling grating; 50, a micro-projector; 60, a functional area grating

### DETAILED DESCRIPTION OF THE EMBODIMENTS

It should be noted that the embodiments in the disclosure and features in the embodiments can be combined without conflicts. Hereinafter, the disclosure will be described in detail with reference to the drawings in combination with embodiments.

It is to be noted that unless otherwise indicated, all technical and scientific terms used in the disclosure have the same meanings as those commonly understood by one of ordinary skill in the art to which the disclosure belongs.

In the disclosure, unless specified to the contrary, the directional terms such as “upper, lower, top, and bottom” are generally used regarding the directions shown in the figures, or for the components themselves in vertical, perpendicular, or gravity directions; likewise, for ease of understanding and description, “inner and outer” refers to the inner and outer relative to the outline of each component itself, but the described directional terms are not used to limit the disclosure.

In order to solve the problem of poor imaging effect of the optical waveguide system in the related art, the disclosure provides an optical waveguide system and a near-eye display.

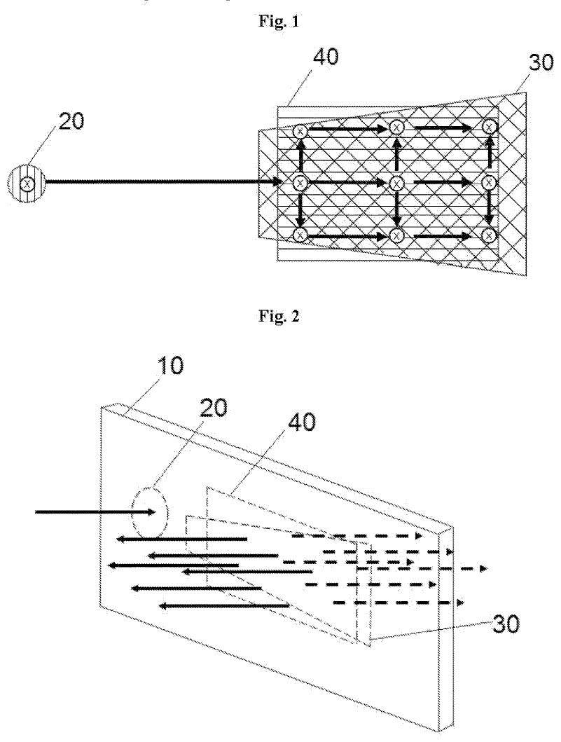

As shown in FIGS. 1-6, the optical waveguide system includes an optical waveguide 10, an in-coupling grating 20, a turning grating 30 and an out-coupling grating 40, the in-coupling grating 20 is arranged on one side surface of the optical waveguide 10, the in-coupling grating 20 is a one-dimensional grating, and the in-coupling grating 20 is configured for coupling light emitted by a micro-projector 50 located externally into the optical waveguide 10; the turning grating 30 is arranged on the optical waveguide 10 and is located on the same side surface or a different side surface of the in-coupling grating 20, the turning grating 30 is a two-dimensional grating, and the turning grating 30 is configured for receiving light of the in-coupling grating 20; the out-coupling grating 40 is arranged on the other side surface of the optical waveguide 10, projections of the turning grating 30 and the out-coupling grating 40 on the optical waveguide 10 at least partially coincide, the out-coupling grating 40 is a one-dimensional grating, and the out-coupling grating 40 is configured for receiving lights of the turning grating 30 and the in-coupling grating 20 and coupling the lights out from the optical waveguide 10 and enter human eyes.

An arrangement of the optical waveguide 10 enables the optical waveguide 10 to provide arrangement positions for the in-coupling grating 20, the turning grating 30 and the out-coupling grating 40, thereby improving usage reliabilities of the in-coupling grating 20, the turning grating 30 and the out-coupling grating 40, meanwhile, ensuring an uniformity of transmission of light in the optical waveguide 10, and ensuring that the optical waveguide system is able to achieve uniform imaging. The in-coupling grating 20 is a one-dimensional grating, so that the in-coupling grating 20 is able to couple most of the light emitted by the micro-projector 50 located externally into an optical waveguide 10, so that the in-coupling grating 20 diffracts the light into light different angles and different orders for transmission, thereby guaranteeing an uniformity of the light transmission in the optical waveguide 10, and guaranteeing an in-coupling efficiency of the in-coupling grating 20. The turning grating 30 is arranged on the optical waveguide 10 and is located on the same side surface or a different side surface of the in-coupling grating 20, the turning grating 30 is a two-dimensional grating, so that the turning grating 30 is able to receive most of the light of the in-coupling grating 20; the light in the optical waveguide 10 is able to be transmitted in a one-dimensional direction or a two-dimensional direction, so as to transmit and expand the light in two specific directions; and an information of the micro-projector 50 is transmitted and expanded, so as to ensure an expanding and uniform light effect of the turning grating 30. The out-coupling grating 40 is arranged on the other side surface of the optical waveguide 10, the out-coupling grating 40 is a one-dimensional grating, and the out-coupling grating 40 is configured for receiving the lights of the turning grating 30 and the in-coupling grating 20, and efficiently coupling the lights out from the optical waveguide 10, so as to uniformly and efficiently couple information of the micro-projector 50 out and enter the human eyes. The projections of the turning grating 30 and the out-coupling grating 40 on the optical waveguide 10 at least partially coincide, such arrangement shortens a distance for light to be transmitted from the turning grating 30 to the out-coupling grating 40, reduces a loss of light intensity energy, increases an out-coupling efficiency, meanwhile, makes the light coupled to the human eyes more uniform, thereby guaranteeing an uniformity of the out-coupled light, enabling an image viewed by a user to be clearer and more uniform, and improving an imaging effect.

In addition, the projections of the turning grating 30 and the out-coupling grating 40 on the optical waveguide 10 at least partially coincide, and this arrangement is able to effectively reduce an occupation area of the turning grating 30 and the out-coupling grating 40 on the optical waveguide 10, thereby ensuring a miniaturization of the optical waveguide system. Thus, the optical waveguide structure of the disclosure is able to obtain a uniform display image by using a relatively small optical waveguide 10, thereby improving a display uniformity.

In an embodiment, the turning grating 30 is arranged on the optical waveguide 10 and is located on a side surface different from the side surface of the in-coupling grating 20, which are able to be selected according to practical situations.

In an embodiment as shown in FIG. 1, the turning grating 30 and the out-coupling grating 40 are respectively arranged on different surfaces of the optical waveguide 10, and projections of the turning grating 30 and the out-coupling grating 40 on the optical waveguide 10 completely correspond to each other and coincide mostly. In an embodiment as shown in FIG. 4, the projections of the turning grating 30 and the out-coupling grating 40 on the optical waveguide 10 are able to not exactly correspond to each other, and as shown in the figure, the projections of the turning grating 30 and the out-coupling grating 40 on the optical waveguide 10 coincide for only a small portion. Of course, a positional relationship and a projection coinciding area of the turning grating 30 and the out-coupling grating 40 are able to be adjusted according to practical situations.

As shown in FIG. 1, the in-coupling grating 20 is the one-dimensional grating, the turning grating 30 is the two-dimensional grating, the out-coupling grating 40 is the one-dimensional grating, the in-coupling grating 20 and the turning grating 30 are on the same side surface of the optical waveguide 10, the out-coupling grating 40 is on the back of the turning grating 30, light passes through the in-coupling grating 20 and reaches the turning grating 30, and is transmitted and expanded to the out-coupling grating 40 by means of the turning grating 30, and then the out-coupling grating 40 couples the light out and enter the human eyes. Such an arrangement enables the turning grating 30 to have functions of expanding and uniform light. In the figure, the turning grating 30 is selected as a square grating, and a angle between k-vector of the square grating is 90 degrees, so that the turning grating 30 is able to perform two-dimensional expanding of light to evenly divide an efficiency of the light, and then reach the out-coupling grating 40; the out-coupling grating 40 is arranged on the back of the turning grating 30, and light diffracted by the turning grating 30 to the position is coupled out, so as to ensure that light transmitted by the turning grating 30 to the out-coupling grating 40 is coupled out and enters the human eyes as much as possible. The specific parameters of the out-coupling grating 40 and the light turning grating 30 are able to be set according to requirements, and heights or duty ratios in different regions are different, and finally, an uniformity of a light intensity of the light coupled out is adjusted to satisfy specific requirements. Meanwhile, this arrangement is able to effectively reduce a size of the optical waveguide 10, so that the optical waveguide 10 is better applicable to a conventional spectacle lens. The solution shown in FIG. 4 is a variant of the solution in FIG. 1, so that a design of the spectacle lens is more suitable to wear .

It should be noted that arrows in FIGS. 1-4 are all transmission directions of light.

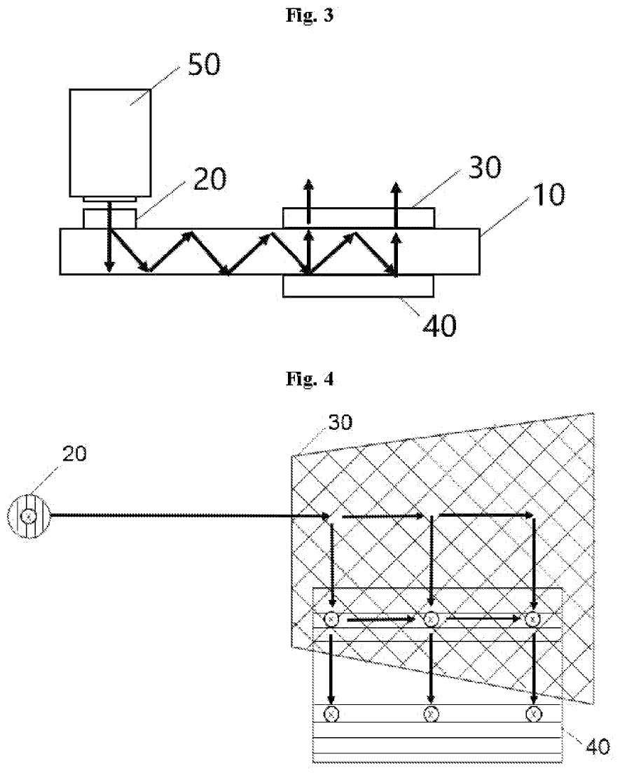

FIG. 3 is a structural schematic diagram of a near-eye display according to the disclosure. It can be seen from the figure that the micro-projector 50 is arranged corresponding to the in-coupling grating 20. There are one or a plurality of micro-projectors 50.

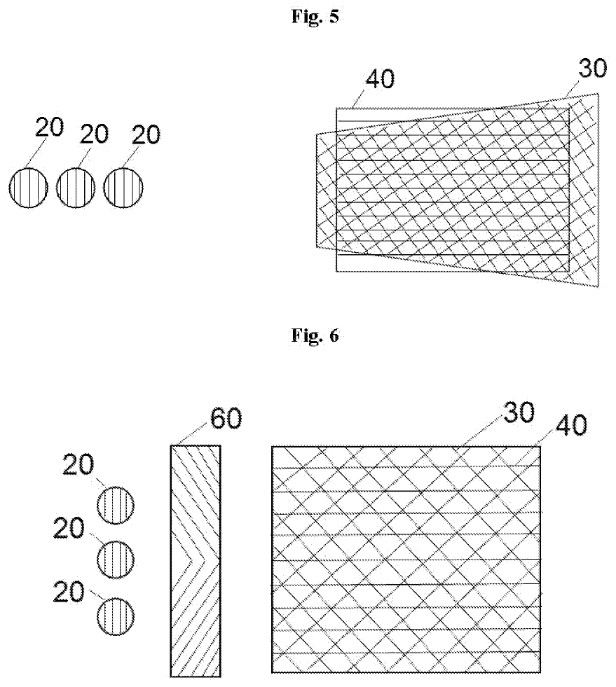

As shown in FIG. 5, as some micro-projectors 50 are able to not be configured for color display separately, and a plurality of monochromatic projectors need to be combined to display color, so that a plurality of in-coupling gratings 20 corresponding to the plurality of micro-projectors 50 are respectively designed on the optical waveguide 10. A separation solution of tricolor RGB projectors is proposed. Two additional in-coupling gratings 20 are added on the basis of the solution in FIG. 1 to perform light transmission of the two additional micro-projectors 50. Because three of the plurality of in-coupling gratings 20 are arranged in a light transmission direction in FIG. 5, the three of the plurality of in-coupling gratings 20 are able to not be arranged on the same optical waveguide 10, so as to avoid crosstalk between the three of the plurality of in-coupling gratings 20; and there are a plurality of optical waveguides 10, the three of the plurality of in-coupling gratings 20 are respectively arranged on three of the plurality of optical waveguides 10, that is to say, each of the plurality of optical waveguides 10 is provided with an in-coupling grating 20, a turning grating 30 and an out-coupling grating 40. Positions of the turning grating 30 and the out-coupling grating 40 on each of the plurality of optical waveguides 10 are consistent, only a position of the in-coupling grating 20 is different, and a transmission principle of light on each of the plurality of optical waveguides 10 in FIG. 5 is consistent with that in FIG. 1.

Specifically, there are a plurality of in-coupling gratings 20, the plurality of in-coupling gratings 20 are located on one side of the turning grating 30, and the plurality of in-coupling gratings 20 are arranged at intervals along a straight line, for example, there may be three coupling gratings 20, the three in-coupling gratings 20 are transversely arranged in a direction as shown in FIG. 5, or the three in-coupling gratings 20 are longitudinally arranged in a direction as shown in FIG. 6, there may be one or a plurality of optical waveguides 10 corresponding to the arrangement manner shown in FIG. 6, that is to say, the three in-coupling gratings 20 are able to be arranged on one optical waveguide 10, or the three in-coupling gratings 20 are able to be arranged on three optical waveguide 10 in one-to-one correspondence, and the three in-coupling gratings 20 are respectively provided with the turning grating 30 and the out-coupling grating 40.

It should be noted that, a number of the plurality of in-coupling gratings 20 and a number of the plurality of optical waveguides 10 are able to be set according to actual situations.

In an embodiment shown in FIG. 6, the optical waveguide 10 further includes a functional area grating 60, the functional area grating 60 is arranged between the in-coupling grating 20 and the turning grating 30, the functional area grating 60 is a one-dimensional grating, and the functional area grating 60 is configured for turning and transmitting the light in-coupled to the in-coupling grating 20, and then the light enters the turning grating 30. The plurality of micro-projectors 50 with three colors are respectively arranged on the same side and correspond to the three in-coupling gratings 20 on a one-to-one basis, so as to be compatible with some design schemes in which the monochromatic projector need the plurality of micro-projectors 50 configurations for color output. In the embodiment, the functional area grating 60 is added between the in-coupling grating 20 and the turning grating 30, the functional area grating 60 is a one-dimensional grating, and grating parameters include a duty ratio of greater than or equal to 30% and less than or equal to 80%, a height of greater than or equal to 30 nm and less than or equal to 300 nm, and a period in a range of 300 nm to 600 nm. In this way, the functional area grating 60 is able to turn lights, which enter from the upper and lower in-coupling gratings 20, to the middle respectively, and then transmit the lights to the turning grating 30, so as to guide the lights to the middle of orbit for color combination, thereby ensuring a uniform image.

Specifically, the one-dimensional grating is one of a blazed grating, a slanted grating, a binary grating, a double-ridged grating and a one-dimensional multi-layer grating; the two-dimensional grating is one of a square grating, a rectangular grating, a parallelogram grating, a diamond grating and a two-dimensional multi-layer grating.

It should be noted that the blazed grating is a grating on which a groove surface is not parallel to a grating normal line, that is, there is a small included angle therebetween and has a blazed characteristic. A sawtooth grating is an optimal blazed grating, and the sawtooth grating has a sawtooth structure on its cross section for diffraction. The slanted grating is a grating in which a plane of the grating forms a certain inclined angle with a tangential direction of the grating. The binary grating is a grating with a rectangular structure on its cross section for diffraction.

Specifically, the in-coupling grating 20 is the one-dimensional grating, and a duty ratio of the in-coupling grating 20 is greater than or equal to 30% and less than or equal to 80%; a height of the in-coupling grating 20 is greater than or equal to 50 nm and less than or equal to 500 nm; when the in-coupling grating 20 is a one-dimensional multi-layer grating, a number of layers of the one-dimensional multi-layer grating is greater than or equal to 1 and less than or equal to 10, a height of each of the layers is greater than or equal to 50 nm and less than 500 nm, and gratings of each of the layers are one-dimensional and have the same structure; a period of the in-coupling grating 20 is great than equal to 300 nm and less than or equal to 600 nm. In this way, it is ensured that the in-coupling grating 20 is able to diffract incident light into light of different angles and different orders for transmission, and a purpose thereof is to introduce light emitted by the micro-projector 50 into the optical waveguide 10 at a maximum efficiency, and specific parameters are able to be adjusted, thereby finally ensuring that the uniformity of the intensity of the out-coupled light satisfies the specific requirement.

Specifically, the turning grating 30 is a two-dimensional grating, that is, there are periodic changes in both directions; duty ratio of the turning grating 30 is greater than or equal to 30% and less than or equal to 80%; a height of the turning grating 30 is greater than or equal to 30 nm and less than or equal to 300 nm; when the turning grating 30 is the two-dimensional multi-layer grating, a number of layers of the two-dimensional multi-layer grating is greater than or equal to 1 and less than or equal to 10, a height of each of the layers is greater than or equal to 30 nm and less than or equal to 300 nm, and gratings of each of the layers are two-dimensional and have the same structure; a period of the turning grating 30 is greater than or equal to 300 nm and less than or equal to 600 nm. In this way, it is ensured that the turning grating 30 is able to transmit light in the optical waveguide 10 in a one-dimensional direction or a two-dimensional direction, and a purpose thereof is to transmit and expand light in a specific direction, and to transmit and expand an information of the micro-projector 50. In an embodiment, the period of the turning grating 30 is a value obtained by dividing the period of the in-coupling grating 20 by the square root of 2. Specific parameters are able to be adjusted, and finally the adjustment ensures that the uniformity of the intensity of the out-coupled light satisfies the specific requirement.

Specifically, a duty ratio of the out-coupling grating 40 is greater than or equal to 30% and less than or equal to 80%; a height of the out-coupling grating 40 is greater than or equal to 30 nm and less than or equal to 300 nm; when the out-coupling grating 40 is the one-dimensional multi-layer grating, a number of layers of the one-dimensional multi-layer grating is greater than or equal to 1 and less than or equal to 10, a height of each of the layers is greater than or equal to 30 nm and less than or equal to 300 nm, and gratings of each of the layers are one-dimensional and have the same structure; a period of the out-coupling grating 40 is greater than or equal to 300 nm and less than or equal to 600 nm. This arrangement ensures that the out-coupling grating 40 is able to stably receive lights transmitted by the turning grating 30 and the in-coupling grating 20, and the lights are further expanded and out-coupled. A purpose thereof is to uniformly and efficiently couple the information of the micro-projector 50 out and into the human eyes. In an embodiment, the period of the out-coupling grating 40 is consistent with the period of the in-coupling grating 20, and specific parameters are able to be adjusted, and finally the adjustment enables the uniformity of the light intensity output by coupling to satisfy specific requirements.

Specifically, a material of the optical waveguide 10 is glass or optical crystal; the glass is a high refractive index glass; the optical crystal is a high refractive index optical crystal; and a refractive index of the optical waveguide 10 is greater than or equal to 1.7 and less than or equal to 2.3. This arrangement helps to ensure a high refractive index characteristic of the optical waveguide 10, and a high refractive index is able to improve a size of a field of view, so as to implement the optical waveguide 10 with an ultra-large field of view. Of course, different materials are able to also be selected according to practical requirements.

Specifically, a thickness of the optical waveguide 10 is greater than or equal to 400 μm and less than or equal to 1 mm. If the thickness of the optical waveguide 10 is less than 400 μm, the optical waveguide 10 is not easy to manufacture, a processing difficulty of the optical waveguide 10 is enhanced, the optical waveguide 10 is easy to break during usage, and a structural strength of the optical waveguide 10 is reduced. If the thickness of the optical waveguide 10 is greater than 1 mm, the thickness of the optical waveguide 10 is too large, which is adverse to a miniaturization of the optical waveguide 10. The thickness of the optical waveguide 10 is limited within a range of 400 μm to 1 mm, thereby ensuring a light and thin optical waveguide 10 and the structural strength of the optical waveguide 10.

It should be noted that, the in-coupling grating 20, the turning grating 30, and the out-coupling grating 40 are all diffraction gratings, so as to ensure a diffraction effect of the in-coupling grating 20, the turning grating 30, and the out-coupling grating 40 on light, and ensure an uniform transmission of light in the optical waveguide 10. Due to characteristics of the diffraction gratings, an intensity of the out-coupled light may have non-uniformity, and the non-uniformity is represented as non-uniformity in space and non-uniformity in angle. The non-uniformity in space results in difference in brightness of an observed image when the human eyes is located at different positions in the orbit, and the non-uniformity in angle results in difference in brightness intensity at different fields of view. The optical waveguide system provided in the disclosure may improve an uniformity of display, reduce the size of the optical waveguide 10, reduce costs, and enable the optical waveguide 10 to be closer to the spectacle lens, so as to be more suitable to wear. Due to a diversity of the micro-projector 50, the disclosure proposes the design scheme of separation of the plurality of micro-projectors 50 with three colors, improving a compatibility of combination.

The near-eye display includes the micro-projector 50 and the optical waveguide system, wherein there are one or a plurality of micro-projectors 50; the micro-projector 50 emits image light to the optical waveguide system, and the optical waveguide system couples the image light out and into the human eyes. As the image light is propagated within the optical waveguide system, the optical waveguide system at least expands the received image light into a one-dimensional light. The in-coupling grating 20 is designed to couple the image light into the optical waveguide 10. The turning grating 30 and the out-coupling grating 40 are designed to output the expanded image light and to couple the image light out and into the human eyes.

It should be noted that, a number of the plurality of micro-projectors 50 is set according to the number of the in-coupling gratings 20, and the plurality of micro-projectors 50 are provided corresponding to the plurality of in-coupling gratings 20.

It should be noted that the micro-projector 50 may be a self-luminous active device, such as a micro-OLED or micro-LED, and may also be a liquid crystal display screen requiring external light source illumination, including a transmissive LCD and a reflective LCOS, and also including a digital micromirror device (DMD) based on micro-electro-mechanical systems (MEMS) technology, i.e. a core of the DLP and a laser beam scanner (LBS). In this way, it is ensured that the micro-projector 50 may provide a monochromatic or colorful image light source information; a size and shape of the light source needs to match a size and shape of the in-coupling grating 20; for example, the micro-projector 50 at a circular in-coupling port needs to match the in-coupling grating 20 which is circular; and different types of micro-projectors 50 are selected for matching according to actual device requirements, so that a performance of the near-eye display is the best.

It should be noted that the near-eye display may be an AR head-mounted device.

Obviously, the embodiments as described are only parts of embodiments rather than all the embodiments of the disclosure. All other embodiments obtained by a person of ordinary skill in the art based on the embodiments of the present disclosure without any inventive effort shall all fall within the scope of protection of the present disclosure.

It should be noted that the terms used herein are for the purpose of describing particular embodiments only and are not intended to limit exemplary embodiments in accordance with the disclosure. As used herein, the singular form is intended to comprise the plural form as well, unless the context clearly indicates otherwise, and further it should be understood that the terms “comprises” and/or “comprising” when used in the present description, specify the presence of features, steps, operations, devices, components and/or combinations thereof.

It is to be noted that terms “first”, “second” and the like in the description, claims and the drawings of the application are configured for distinguishing similar objects rather than describing a specific sequence or a precedence order. It should be understood that the data so used may be interchanged where appropriate so that the embodiments of the disclosure described herein may be implemented in sequences other than those illustrated or described herein.

The above is only preferred embodiments of the disclosure and is not intended to limit the disclosure. Those skilled in the art may make various modifications and variations. Any modifications, equivalent replacements, improvements, etc. made within the spirit and principle of the disclosure shall all fall within the scope of protection of the disclosure.

What is claimed is:

1. An optical waveguide system, comprising:
an optical waveguide;
an in-coupling grating, the in-coupling grating is arranged on one side surface of the optical waveguide, the in-coupling grating is a one-dimensional grating, and the in-coupling grating is configured for coupling light emitted by a micro-projector located externally into the optical waveguide;
a turning grating, the turning grating is arranged on the optical waveguide and is located on the same side surface or a different side surface of the in-coupling grating, the turning grating is a two-dimensional grating, and the turning grating is configured for receiving and expanding light of the in-coupling grating; and
an out-coupling grating, the out-coupling grating is arranged on the other side surface of the optical waveguide, projections of the turning grating and the out-coupling grating on the optical waveguide at least partially coincide, the out-coupling grating is a one-dimensional grating, and the out-coupling grating is configured for receiving lights from the turning grating and the in-coupling grating and coupling the lights out from the optical waveguide.

2. The optical waveguide system according to claim 1, wherein there are a plurality of in-coupling gratings, the plurality of in-coupling gratings are located on one side of the turning grating, and the plurality of in-coupling gratings are arranged at intervals along a straight line.

3. The optical waveguide system according to claim 2, wherein there are one or a plurality of optical waveguides; when there are the plurality of optical waveguides, the plurality of optical waveguides are arranged in a stacked manner; the in-coupling grating, the turning grating and the out-coupling grating are correspondingly arranged on each of the plurality of optical waveguides; and projections, on adjacent optical waveguide, of each of in-coupling gratings on the plurality of optical waveguides coincide or do not coincide.

4. The optical waveguide system according to claim 2, wherein the optical waveguide further comprises a functional area grating, the functional area grating is arranged between the in-coupling grating and the turning grating, the functional area grating is a one-dimensional grating, and the functional area grating is configured for turning and transmitting the light of the in-coupling grating, and then entering the turning grating.

5. The optical waveguide system according to claim 1, wherein
the one-dimensional grating is one of a blazed grating, a slanted grating, a binary grating, a double-ridged grating and a one-dimensional multi-layer grating; and/or
the two-dimensional grating is one of a square grating, a rectangular grating, a parallelogram grating, a diamond grating and a two-dimensional multi-layer grating.

6. The optical waveguide system according to claim 1, wherein a duty ratio of the in-coupling grating is greater than or equal to 30% and less than or equal to 80%.

7. The optical waveguide system according to claim 1, wherein when the in-coupling grating is a one-dimensional multi-layer grating, a number of layers of the one-dimensional multi-layer grating is greater than or equal to 1 and less than or equal to 10.

8. The optical waveguide system according to claim 1, wherein a height of the in-coupling grating is greater than or equal to 50 nm and less than or equal to 500 nm.

9. The optical waveguide system according to claim 1, wherein a period of the in-coupling grating is greater than or equal to 300 nm and less than or equal to 600 nm.

10. The optical waveguide system according to claim 1, wherein a duty ratio of the turning grating is greater than or equal to 30% and less than or equal to 80%.

11. The optical waveguide system according to claim 1, wherein when the turning grating is a two-dimensional multi-layer grating, a number of layers of the two-dimensional multi-layer grating is greater than or equal to 1 and less than or equal to 10.

12. The optical waveguide system according to claim 1, wherein a height of the turning grating is greater than or equal to 30 nm and less than or equal to 300 nm.

13. The optical waveguide system according to claim 1, wherein a period of the turning grating is greater than or equal to 300 nm and less than or equal to 600 nm.

14. The optical waveguide system according to claim 1, wherein a duty ratio of the out-coupling grating is greater than or equal to 30% and less than or equal to 80%.

15. The optical waveguide system according to claim 1, wherein when the out-coupling grating is a one-dimensional multi-layer grating, a number of layers of the one-dimensional multi-layer grating is greater than or equal to 1 and less than or equal to 10.

16. The optical waveguide system according to claim 1, wherein a height of the out-coupling grating is greater than or equal to 30 nm and less than or equal to 300 nm.

17. The optical waveguide system according to claim 1, wherein a period of the out-coupling grating is greater than or equal to 300 nm and less than or equal to 600 nm.

18. The optical waveguide system according to claim 1, wherein a material of the optical waveguide is glass or optical crystal, the glass is a high refractive index glass, and the optical crystal is a high refractive index optical crystal.

19. The optical waveguide system according to claim 1, wherein
a refractive index of the optical waveguide is greater than or equal to 1.7 and less than or equal to 2.3; and/or
a thickness of the optical waveguide is greater than or equal to 400 μm and less than or equal to 1 mm.

20. A near-eye display, comprising:
a micro-projector, there are one or a plurality of micro-projectors; and
the optical waveguide system according to claim 1, the micro-projector emits image light to the optical waveguide system, and the optical waveguide system couples the image light out and into human eyes.
